(19) United States
(12) Patent Application Publication
(10) Pub. No.: US 2007/0185617 A1
(43) Pub. Date: Aug. 9, 2007

(54) Autonomous mobile robot and method of controlling the same

(75) Inventors: Yeon-ho Kim, Yongin-si (KR); Seok-won Bang, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/606,329

(22) Filed: Nov. 30, 2006

(30) Foreign Application Priority Data
Feb. 7, 2006 (KR) 10-2006-0011823

(51) Int. Cl. G06F 19/00

(52) U.S. Cl. 700/245

(57) ABSTRACT

An autonomous mobile robot and a method of controlling the same, A mobile robot includes: a light-emitting unit projecting light onto a target position on a motion surface, on which the robot moves under control of a user; a position coordinate calculation unit calculating position coordinates of the target position based on a distance between a body of the robot and a target position onto which the light-emitting unit projects light; and a driving unit moving the robot according to the calculated position coordinates of the target position.

### CROSS-REFERENCE TO RELATED APPLICATION

This application claims priority from Korean Patent Application No. 10-2006-0011823 filed on Feb. 7, 2006 in the Korean Intellectual Property Office, the disclosure of which is incorporated herein by reference.

### BACKGROUND OF THE INVENTION

1. Field of the Invention

The present invention relates to an autonomous mobile robot and a method of controlling the same and, more particularly, to an autonomous mobile robot which autonomously moves to a target position once a user intuitively designates the target position and a method of controlling the autonomous mobile robot.

2. Description of Related Art

Conventional methods of controlling a mobile robot to move to a target position include a direct control method and an indirect control method. In the direct control method, a user directly controls a mobile robot to move to a target position. In the indirect control method, a user projects light onto a target position using a control device, and the mobile robot senses the projected light and moves to the target position.

According to the direct control method in which a user directly controls a mobile robot to move to a target position, a robot 11 includes a reception unit 11a receiving a control signal from a remote control 12 under the control of a user as illustrated in FIG. 1. The user controls a path along which the robot 11 moves using the remote control 12 until the robot 11 arrives at a target position 13.

The remote control 12 includes a plurality of direction keys used to control the path of the robot 11. The user controls the path of the robot 11 using the direction keys implemented in the remote control 12.

However, in the direct method, the user directly controls the robot 11 until the robot 11 arrives at the target position. Thus, the user has to continuously intervene in the path along which the robot 11 moves until the robot 11 arrives at the target position 13, which undermines user convenience.

In the indirection method in which a user projects light onto a target position using a control device and the mobile robot senses the projected light and moves to the target position, a robot 21 includes a sensor 21a sensing light projected from a remote control 22 onto a target position 23, such as a camera, as illustrated in FIG. 2.

In the indirection method, after the user projects light onto the target position 23, there is no need for the user to intervene in the path of the robot 21. Consequently, user convenience is enhanced. However, if the position of the sensor 21a included in the robot 21 is low, it is difficult for the sensor 21a to sense a luminous point of light projected from the remote control 22 which is located a large distance from the robot 21. Furthermore, since a light-emitting device is additionally included in the remote control 22 to project light and the sensor 21a is also additionally included in the robot 21 to sense a luminous point of the projected light, the user has to bear the additional costs for the light-emitting device and the sensor 21a when purchasing the robot 21.

Korean Patent Publication No. 2000-0002483 discloses an apparatus for recognizing a cleaning zone, the apparatus being included in a cleaning robot. The apparatus includes a driving unit driving a charge-coupled device (CCD) camera used to take a photograph of a surrounding environment of the cleaning zone, a driving unit driving a laser beam transmission device to form a laser beam point, a camera motor driving unit, a control unit controlling the CCD camera to take a photograph of the surrounding environment in which the laser beam point is formed and recognizing the cleaning zone using the photographed image of the surrounding environment. The apparatus is designed to accurately recognize the cleaning zone using the CCD camera and the laser beam transmission device and determine a navigation path of the cleaning robot based on the recognized cleaning zone so that the cleaning robot can clean the cleaning zone along the determined navigation path. However, this conventional art fails to suggest a method of minimizing user intervention and manufacturing costs of a robot and enabling the robot to autonomously move to a target position.

### BRIEF SUMMARY

An aspect of the present invention provides an autonomous mobile robot which can autonomously move to a target position, thereby minimizing user intervention, and a method of controlling the autonomous mobile robot.

According to an aspect of the present invention, there is provided a mobile robot includes: a light-emitting unit projecting light onto a target position on a motion surface, on which the robot moves under control of a user; a position coordinate calculation unit calculating position coordinates of the target position based on a distance between a body of the robot and a target position onto which the light-emitting unit projects light; and a driving unit moving the robot according to the calculated position coordinates of the target position.

According to another aspect of the present invention, there is provided a method of controlling a mobile robot, the method including: projecting light onto a target position on a motion surface, on which the robot moves, using a light-emitting device installed on one side of a body of the robot; calculating position coordinates of the target position based on a distance between the body and a target position onto which the light-emitting device projects light; and moving the robot according to the calculated position coordinates of the target position.

According to another aspect of the present invention, there is provided a method of controlling a robot, including: projecting a light from the robot at a target point on a surface on which the robot moves, the target point being a location to which the robot is to move; calculating position coordinates of the target point relative to the robot based on a distance between the robot and target point; and moving the robot to the position coordinates of the target point.

According to another aspect of the present invention, there are provided computer-readable storage media encoded with processing instructions for causing a processor to execute the aforementioned methods.

Additional and/or other aspects and advantages of the present invention will be set forth in part in the description which follows and, in part, will be obvious from the description, or may be learned by practice of the invention.

### BRIEF DESCRIPTION OF THE DRAWINGS

The above and/or other aspects and advantages of the present invention will become apparent and more readily appreciated from the following detailed description, taken in conjunction with the accompanying drawings of which:

FIG. 1 is a perspective view of a conventional robot whose path to a target position is directly controlled by a user;

FIG. 2 is a perspective view of another conventional robot which senses light projected onto a target position and moves to the target position;

FIG. 3 is a block diagram of an autonomous mobile robot according to an embodiment of the present invention;

FIG. 4 is a perspective view of the autonomous mobile robot of FIG. 3;

FIG. 5 a schematic view illustrating a luminous point of light projected onto a motion surface from a light-emitting unit according to an embodiment of the present invention;

FIG. 6 is a schematic view of a lens according to an embodiment of the present invention;

FIG. 7 is a perspective view illustrating position coordinates of a target position calculated based on the distance between the target position and a body of the autonomous mobile robot of FIG. 3;

FIG. 8 is a schematic view of a user input unit according to an embodiment of the present invention; and

FIG. 9 is a flowchart illustrating a method of controlling an autonomous mobile robot according to an embodiment of the present invention.

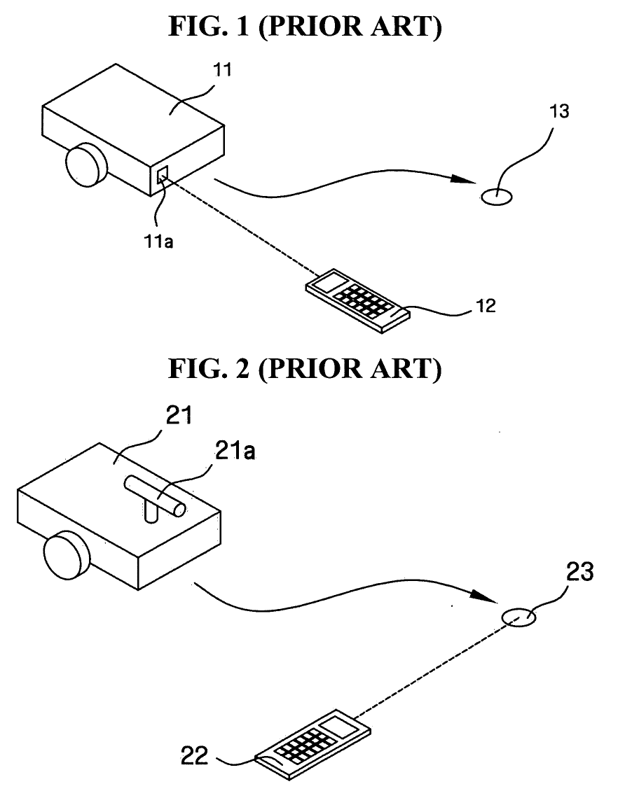

### DETAILED DESCRIPTION OF EMBODIMENTS

Reference will now be made in detail to embodiments of the present invention, examples of which are illustrated in the accompanying drawings, wherein like reference numerals refer to the like elements throughout. The embodiments are described below in order to explain the present invention by referring to the figures.

Embodiments of the present invention will hereinafter be described with reference to block diagrams or flowcharts. It is to be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks. And each block of the flowchart illustrations may represent a module, segment, or portion of code, which comprises one or more executable instructions for implementing the specified logical function(s). It is also to be noted that in some alternative implementations, the functions noted in the blocks may occur in an order that differs from that described/illustrated. For example, two blocks shown in succession may in fact be executed substantially concurrently or the blocks may sometimes be executed in the reverse order, depending upon the functionality involved.

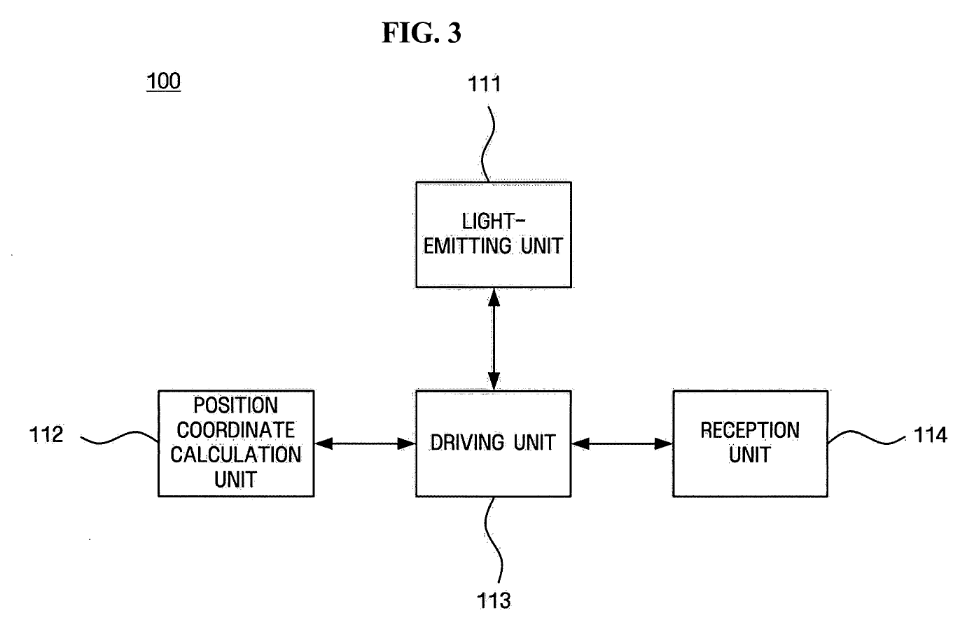

FIG. 3 is a block diagram of an autonomous mobile robot 100 according to an embodiment of the present invention. Referring to FIG. 3, the autonomous mobile robot 100 includes a light-emitting unit 111, a position coordinate calculation unit 112, a driving unit 113, and a reception unit 114. The light-emitting unit 111 is installed on one side of a body 120 of the autonomous mobile robot 100, which can move along a predetermined motion surface, and projects light onto a target position on the motion surface under the control of a user. The position coordinate calculation unit 112 calculates position coordinates of the target position based on the distance between the body of the autonomous mobile robot 100 and a luminous point, i.e., the target position, onto which light is projected. The driving unit 113 moves the body of the autonomous mobile robot 100 to the target position according to the calculated position coordinates. The reception unit 114 receives a control signal for changing a direction in which light is projected.

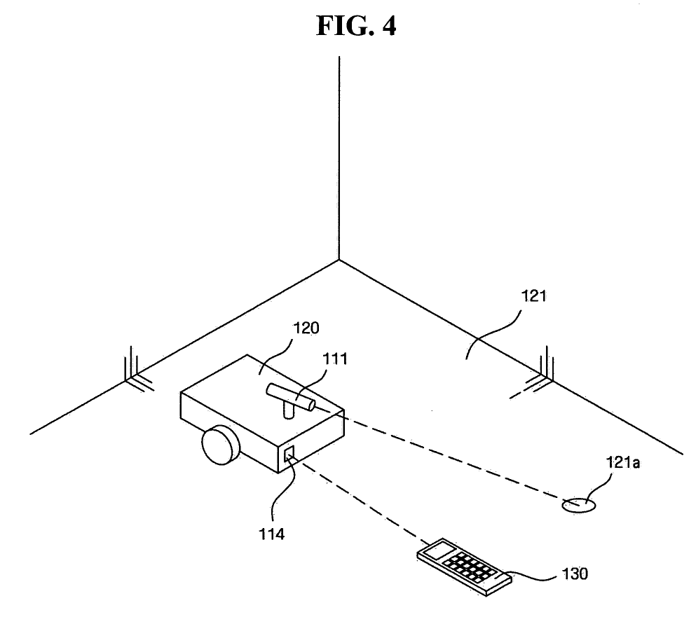

Specifically, referring to FIG. 4, the light-emitting unit 111 is installed on one side (e.g., the top) of the body 120 of the autonomous mobile robot 100, which can move along a predetermined motion surface 121, and projects light onto a position 121a on the motion surface 121 along which the body 120 moves. The position 121a on the motion surface 121 onto which the light-emitting unit 111 projects light can be a target position.

The position 121a, onto which the light-emitting unit 111 projects light, may be changed by the user. The user may change the position 121a using a control device 130, which will be described later. In the present embodiment, the control device 130 is a remote control remotely controlling the position 121a, onto which the light-emitting unit 111 projects light, through wireless communication. However, it is to be understood that this is a non-limiting example. The reception unit 114 included in the body 120 may receive a control signal from the control device 130, and the light-emitting unit 111 may change the light projection direction in response to the received control signal. Hereinafter, a luminous point, i.e., the position 121a, onto which the light-emitting unit 111 projects light, will be referred to as a target position 121a.

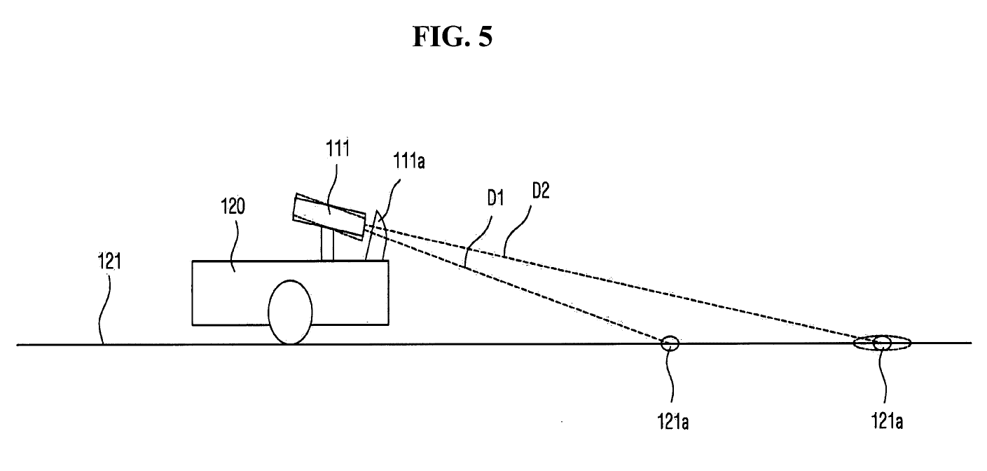

As the distance between the target position 121a and the body 120 increases, the shape of the target position 121a on the motion surface 121, onto which light is projected from the light-emitting unit 111, changes from an elliptical round-like shape to an elliptical oval-like shape. In detail, referring to FIG. 5, the target position 121a onto which light is projected from the light-emitting unit 111 is round-like when a distance D1 between the target position 121a and the body 120 is short. However, the target position 121a becomes oval-like when the body 120 is located a greater distance D2 from the target position 121a than the distance D1. That is, the eccentricity of the ellipse increase as distance D increases so that the ellipse shape becomes more pronounced.

As described above, when a luminous point, i.e., the target position 121a, becomes oval-like, it is difficult for the user to control the light-emitting unit 111 to project light precisely onto the target position 121a using the control device 130. To compensate for the phenomena, a lens 111a having a different curvature according to the light projection direction may be installed on a front surface of the light-emitting unit 111 as illustrated in FIG. 5.

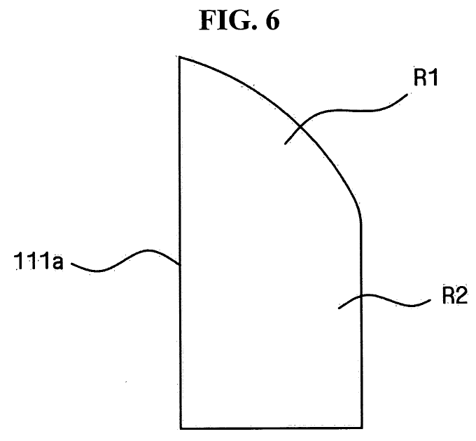

Referring to FIG. 6, the lens 111a installed on the front surface of the light-emitting unit 111 enables the luminous point, i.e., the target position 121a, to maintain the round shape even when the body 120 is located a great distance from the target position 121a. In detail, a curvature R2 of the lens 111a when the body 120 is located a short distance from the target position 121a is less than a curvature R1 when the body 120 is located further from the target position 121a. Therefore, even when the target position 121a is at a great distance from the body 120, the target position 121a can still be a round-like shape.

It is to be appreciated that by maintaining a round-like shape (i.e., low eccentricity) of the projected light emitted from the light-emitting unit 111 onto the motion surface 121, a user can to precisely designate the target position 121a.

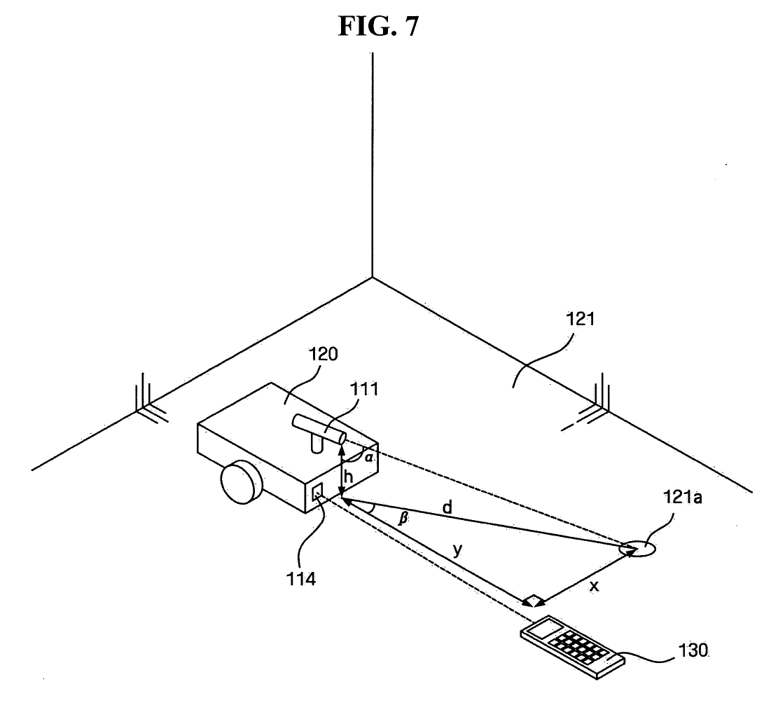

Referring to FIGS. 3 and 7, the position coordinate calculation unit 112 can calculate a distance d between the body 120 and the target position 121a using a distance (hereinafter, referred to as height h) between the motion surface 121 and the light-emitting unit 111 and an angle α formed by a plane perpendicular to the motion surface 121 and light projected from the light-emitting unit 111. The distance d between the body 120 and the target position 121a may be given by Equation (1):

d=h×tan α (1).

The position coordinate calculation unit 112 can also calculate position coordinates of the target position 121a with respect to a current position of the body 120 based on the distance d between the body 120 and the target position 121a calculated using Equation (1). The present embodiment will hereinafter be described assuming that an axis that coincides with a direction in which the robot 100 moves is a y axis and an axis perpendicular to the direction in which the robot 100 moves is an x axis as illustrated in FIG. 7. The terms “x axis” and “y axis” used herein are relative examples only, and are used to facilitate understanding of the present embodiment.

Specifically, the position coordinate calculation unit 112 can calculate an x-axis coordinate and a y-axis coordinate using an angle β formed by the direction in which the body 120 moves and the target position 121a and the distance d calculated using Equation (1). The x-axis coordinate and the y-axis coordinate may be given by Equation set (2):

X=d×sin β; and

Y=d×cos β (2).

The driving unit 113 may be a driving motor which rotates a wheel installed on one side of the body 120 of the robot 100 in order to move the robot 100. The driving unit 113 rotates the wheel according to the position coordinates of the target position 121a calculated by the position coordinate calculation unit 112 using Equation set (2) so that the robot 100 can move to the target position 121a.

The control device 130 may be a remote control which can transmit a control signal corresponding to a value input by the user to the body 120. According to the present embodiment, the control device 130 transmits the control signal to the body 120 through wireless communication. However, it is to be understood that this is a non-limiting example. The control device 130 may also be a controller connected to the body 120 through a cable and a predetermined input/output port implemented in the body 120.

The control signal transmitted from the control device 130 according to the value input by the user may be a value for changing the light projection direction of the light-emitting unit 111. Therefore, the user can change the target position 121a by changing the light projection direction of the light-emitting unit 111 using the control device 130.

When the user changes the light projection direction of the light-emitting unit 111, it becomes more difficult for the user to precisely designate the target position 121a as the distance between the body 120 and the target position 121a increases. That is because the linear speed of the target position 121a is proportional to the distance between the body 120 and the target position 121a, compared with the angular speed of the light-emitting unit 111. In other words, as the distance between the target position 121a and the body 120 increases, the distance by which the target position 121a is changed is relatively greater than an angle at which the light-emitting unit 111 rotates. Hence, it is difficult for the user to precisely designate the target position 121a.

In the present embodiment, it may be assumed that the position coordinates of the target position 121a are composed of the x-axis coordinate and the y-axis coordinate. Hence, a linear speed \dot{x} in an x-axis direction and a linear speed \dot{y} in a y-axis direction may be obtained after the distance d between the body 120 and the target position 121a is multiplied by an angular speed \dot{β} in the x-axis direction and an angular speed \dot{α} in the y-axis direction, respectively. The linear speed \dot{x} in the x-axis direction and the linear speed \dot{y} in the y-axis direction may be given by Equation set (3):

\dot{x}=d×\dot{β}; and

\dot{y}=d×\dot{α} (3).

According to Equation set (3), as the distance d between the body 120 and the target position 121a increases, linear speed changes greatly. Thus, it is difficult for the user to precisely designate the target position 121a. In this regard, angular speed is controlled to have values (\dot{β}=\dot{x}/d, \dot{α}=\dot{y}/d), which are inversely proportional to the distance d between the body 120 and the target position 121a, in response to the change of the linear speed. Consequently, the user can precisely designate the position of the luminous point even when the distance d between the body 120 and the target position 121a increases.

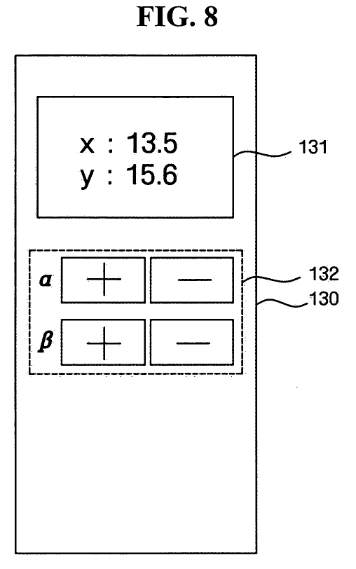

As illustrated in FIG. 8, the control device 130 may include a display unit 131 displaying the position coordinates of the target position 121a of, e.g., FIG. 7, calculated by the position calculation unit 112 and an angle change unit 132 including a plurality of direction keys for controlling the light projection direction of the light-emitting unit 111.

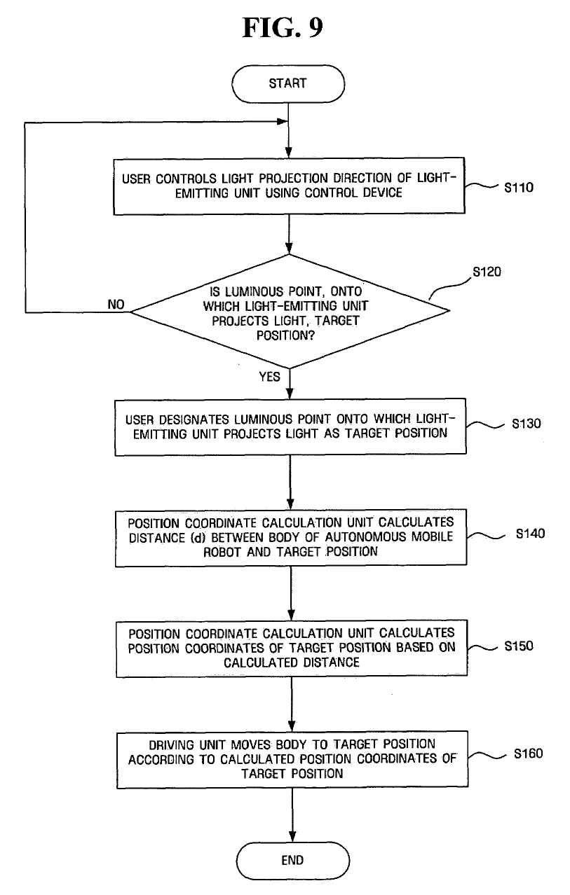

FIG. 9 is a flowchart illustrating a method of controlling an autonomous mobile robot according to an embodiment of the present invention. The method is described in conjunction with the apparatus of FIG. 3 for ease of explanation only.

Referring to FIGS. 3, 5, 7, and 9, a user controls a direction in which the light-emitting unit 111 projects light using the control device 130 (operation S110).

If a luminous point onto which the light-emitting unit 111 projects light under the control of the user is the desired target position 121a (operation S120), the user designates the luminous point on the motion surface 121 onto which the light-emitting unit 111 projects light as the target position 121a (operation S130). Specifically, the user controls the light projection direction of the light-emitting unit 111 using the angle change unit 132 of the control device 130. Then, when the light-emitting unit 111 projects light onto the desired target position 121a, the user commands the body 120 to move to the target position 121a using the control device 130, and the body 120 receives a control signal indicating the user command through the reception unit 114.

The luminous point on the motion surface 121 onto which the light-emitting unit 111 projects light under the control of the user may be the target position of the body 120. In the present embodiment, the lens 111a having a different curvature according to the light projection direction of the light-emitting unit 111 may be included in the light-emitting unit 111 to prevent the luminous point of the projected light from transforming into an oval shape from a round shape as the distance between the body 120 and the target position 121a increases.

When the target position 121a is designated, the position coordinate calculation unit 112 may calculate the distance d between the body 120 and the target position 121a using Equation (1) described above (operation S140). The distance d between the body 120 and the target position 121a can be calculated using the height h of the light-emitting unit 111 with respect to the motion surface 121 and an angle formed by a plane perpendicular to the motion surface 121 and the light projection direction of the light-emitting unit 111.

The position coordinate calculation unit 112 may also calculate the position coordinates of the target position 121a with respect to the current position of the body 120 using the calculated distance d and Equation set (2) (operation S150).

The position coordinates of the target position 121a calculated by the position coordinate calculation unit 112 are transmitted to the control device 130 and displayed on the display unit 131. Therefore, the user can identify the position coordinates of the target position 121a and the path along which the body 120 moves through the position coordinates displayed on the display unit 131.

The driving unit 113 moves the robot according to the position coordinates calculated by the position coordinate calculation unit 113 so that the body 120 can move to the target position (operation S160).

As described above, after the user designates the target position 121a toward which the autonomous mobile robot 100 is to move, the autonomous mobile robot 100 according to the present embodiment calculates the position coordinates of the target position 121a based on the distance between the body 120 and the target position 121a and moves to the target position 121a according to the calculated position coordinates of the target position 121a. Therefore, once the user designates the target position by projecting light using the light-emitting unit 111, no user intervention is required.

In addition, the position coordinates of the target position 121a are calculated by using the position of the light-emitting unit 111 which projects light, not by sensing light projected onto the motion surface 121. Therefore, no additional device for sensing light projected onto the target position 121a is required, thereby saving costs. In other words, this combination of features can provide a mobile robot which provides enhanced convenience at low cost.

According to an autonomous mobile robot and a method of controlling the same according to the above-described embodiments, once a user designates a target position using a light-emitting unit, the autonomous mobile robot calculates position coordinates of the target position and autonomously moves to the target position based on the calculated position coordinates of the target position. Hence, user intervention can be minimized, and costs can be saved since no additional device for sensing the target position is required.

The term “unit” used in this disclosure refers to a software program or a hardware device (such as a field programmable gate array (FPGA) or an application specific integrated circuit (ASIC)) which performs a predetermined function. However, the present invention is not restricted to this. In particular, units may be implemented in a storage medium which can be addressed or may be configured to be able to execute one or more processors. Examples of the units include software components, object-oriented software components, class components, task components, processes, functions, attributes, procedures, sub-routines, program code segments, drivers, firmware, microcode, circuits, data, databases, data architecture, tables, arrays, and variables. The functions provided by components or units may be integrated with one another so that they can executed by a smaller number of components or units or may be divided into smaller functions so that they need additional components or units.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A mobile robot comprising:
a light-emitting unit projecting light onto a target position on a motion surface, on which the robot moves, under control of a user;
a position coordinate calculation unit calculating position coordinates of the target position based on a distance between a body of the robot and a target position onto which the light-emitting unit projects light; and
a driving unit moving the robot according to the calculated position coordinates of the target position.

2. The robot of claim 1, wherein the light-emitting unit comprises a lens having a curvature which differs according to a light projection direction of the light-emitting unit such that the projected light at the target position is round-like regardless of the distance.

3. The robot of claim 1, wherein the position coordinate calculation unit calculates the distance between the body and the target position based on a distance between the motion surface and the light-emitting unit and an angle formed by a plane perpendicular to the motion surface and the projected light.

4. The robot of claim 3, wherein a linear speed of the luminous point is proportional to the calculated distance, and an angular speed of the light-emitting unit is inversely proportional to the calculated distance.

5. The robot of claim 3, wherein the position coordinate calculation unit calculates the position coordinates of the target position based on an angle formed by a direction in which the robot moves and the target position and the calculated distance.

6. The robot of claim 5, wherein the position coordinates comprise a coordinate on an axis which coincides with the direction in which the robot moves and a coordinate on an axis perpendicular to the direction in which the robot moves.

7. The robot of claim 1, further comprising a reception unit receiving a control signal for changing the light projection direction of the light-emitting unit, which is transmitted from a control device according to a value input by the user.

8. The robot of claim 7, wherein the control device comprises:
a display unit displaying the calculated position coordinates of the target position; and
an angle change unit comprising a plurality of direction keys used to change an angle at which the light-emitting unit projects light.

9. A method of controlling a mobile robot, the method comprising:
projecting light onto a target position on a motion surface, on which the robot moves, using a light-emitting device installed on one side of a body of the robot;
calculating position coordinates of the target position based on a distance between the body and a target position onto which the light-emitting device projects light; and
moving the robot according to the calculated position coordinates of the target position.

10. The method of claim 9, wherein the light-emitting device comprises a lens having a curvature which differs according to a light projection direction of the light-emitting device such that the projected light at the target position is round-like regardless of the distance.

11. The method of claim 9, wherein the calculating of the position coordinates of the target position comprises calculating a distance between the body and the target position based on a distance between the motion surface and the light-emitting device and an angle formed by a plane perpendicular to the motion surface and the projected light.

12. The method of claim 11, wherein a linear speed of the luminous point is proportional to the calculated distance, and an angular speed of the light-emitting device is inversely proportional to the calculated distance.

13. The method of claim 11, wherein the calculating of the position coordinates of the target position comprises calculating the position coordinates of the target position based on an angle formed by a direction in which the robot moves and the target position and the calculated distance.

14. The method of claim 13, wherein the position coordinates comprise a coordinate on an axis which coincides with the direction in which the robot moves and a coordinate on an axis perpendicular to the direction in which the robot moves.

15. The method of claim 9, further comprising receiving a control signal for changing the light projection direction of the light-emitting device, which is transmitted from a control device according to a value input by a user.

16. The method of claim 15, wherein the control device comprises:
a display unit displaying the calculated position coordinates of the target position; and
an angle change unit comprising a plurality of direction keys used to change an angle at which the light-emitting unit projects light.

17. A computer-readable storage medium encoded with processing instructions for causing a processor to execute the method of claim 9.
